(19) United States
(12) Patent Application Publication
(10) Pub. No.: US 2020/0372486 A1
(43) Pub. Date: Nov. 26, 2020

(54) METHOD AND USE OF PAYMENT CARD POINT OF SALE DEVICES AS Wi-Fi SCANNERS

(71) Applicant: Scott Cay, Windermere, FL (US)

(72) Inventor: Scott Cay, Windermere, FL (US)

(73) Assignee: Scott Cay, Windermere, FL (US)

(21) Appl. No.: 16/421,389

(22) Filed: May 23, 2019

(51) Int. Cl. G06Q 20/20; G06Q 20/34; G06Q 20/40

(52) U.S. Cl. CPC G06Q 20/204; G06Q 20/4016; G06Q 20/356

(57) ABSTRACT

The present solution comprises the use payment card point of sale (POS) devices, also known as Point of Interaction (POI) or Pin Entry Device (PED), to act as a wireless network scanner. Built-in and/or add-on wireless network adapters can scan the surrounding wireless network, collect relevant data, and send said data to a centralized server. The data in said centralized server is monitored, reported, and alerted upon.

### CROSS-REFERENCE TO RELATED APPLICATIONS

This application claims the benefit of provisional patent application Ser. No. 62/677,051, filed 2018 May 27 by the present inventor, and titled “Method and New Use of Payment Card Readers as WIFI Scanners.”

### STATEMENT REGARDING FEDERALLY SPONSORED RESEARCH OR DEVELOPMENT

Not Applicable

### THE NAMES OF THE PARTIES TO A JOINT RESEARCH AGREEMENT STATEMENT REGARDING PRIOR DISCLOSURES BY THE INVENTOR OR A JOINT INVENTOR

Not Applicable

### TECHNICAL FIELD

The present subject matter relates to wireless computing and wireless networking. More specifically, the present subject matter relates to using payment card point of sale (POS) devices as a network scanner designed to search for wireless access points and provide information regarding one or more wireless networks present and available in a scanned location.

### BACKGROUND

The following is a tabulation of some prior art that presently appears relevant:

### U. S. Patents

| Patent Number | Kind Code | Issue Date | Patentee |
|---|---|---|---|
| 7,466,986 | B1 | 2008-12-16 | Halcrow et at. |
| 7,672,257 | 82 | 2010-03-02 | Mahany et al. |
| 8,633,853 | B2 | 2014-01-21 | Amidi |

### U. S. Patent Application Publications

| Patent Number | Kind Code | Publ. Date | Patentee |
|---|---|---|---|
| 2005/0176420 | A1 | 2005-08-11 | Graves et al. |

### Foreign Patent Documents

| | Cntry | Kind | | |
|---|---|---|---|---|
| Foreign Doc. Nr. | Code | Code | Pub. Dt. | App or Patentee |
| CN102316555A | CN | | 2012-01-11 | [symbol] et al. |
| CN201828998U | CN | | 2011-05-11 | [symbol] |
| EP065061881 | EP | B1 | 2000-02-16 | Campo et al. |
| ES2502341T3 | ES | T3 | 2014-10-03 | Lund |

### Nonpatent Literature Documents

Christie, Scott. “War Pi.” SANS Reading Room. Dec. 16, 2013, www.sans.org/reading-roomf/whftepapers/networkdevs/war-pi-34435.
PCI Security Standards Council. “Payment Card Industry (PCI) Data Security Standard: Requirements and Security Assessment Procedures, Version 3.2.1.” May 2018, www.pcisecuritystandards.org/documents/PCI_DSS_v3-2-1.pdf.

With the proliferation of wireless networking devices in merchant business areas and merchants needing to meet regulatory requirements, such as the Payment Card Industry Data Security Standard (PCI DSS), merchants must protect their business areas from unauthorized and/or misconfigured Wireless Fidelity (Wi-Fi) networks. For any merchants accepting payment cards for transactions, there are regulatory requirements to scan or test within a merchant's environment for unauthorized and/or misconfigured wireless network access points (AP). A rogue AP (malicious or not) creates an entry point for unauthorized devices and users into a secured network. Misconfigured access points can also open the network or prevent access for users in a particular area.

The PCI Data Security Standard 3.2.1 (May 2018) specifically calls out this risk and requires wireless network scans or testing in section 11.1:
“Implement processes to test for the presence of wireless access points (802.11), and detect and identify all authorized and unauthorized wireless access points on a quarterly basis.”

The desired state of security and/or compliance requirements is difficult for small merchants to meet without resources or skill to complete an adequate wireless test. Specialized equipment is expensive and may not function properly without proper user skill. Outsourcing the wireless network security testing/monitoring is expensive for small merchants.

Large merchants have difficulty meeting the desired state of security and/or compliance requirements because of the size and distribution of the cardholder data environment (CDE). Testing the wireless networks throughout the entire CDE in all sites across geographic locations is resource intensive. Continuous monitoring/testing requires a dedicated staff and additional equipment further adding to the expense of security.

Merchants with mobile payment card points of sale (POS) have difficulty testing wireless networks as the CDE will change often. Carrying along network testing equipment continuously is an extra burden to the mobility of the merchant.

### SUMMARY

The present solution comprises the use of a payment card POS device, also known as Point of Interaction (POI) or Pin Entry Device (PED), to act as a wireless network scanner. Said payment card POS devices use built-in and/or add-on wireless network adapters to scan the surrounding wireless network, collect relevant data, and send said data to a centralized server. The data in the centralized server is monitored, reported, and alerted upon.

The wireless network scans from the payment card POS can be performed on a regular schedule or manually started. This allows for continuous monitoring, with the flexibility to test on-demand, in the majority of the cardholder data environment (CDE). Testing can be scheduled for any suitable time of day including after business hours when staff are not present. Testing can also be scheduled for desired frequency including but not limited to quarterly (as per PCI-DSS requirements), daily, or hourly.

On-demand or manually started testing can be used to meet a specialized and non-programmable time. The on-demand scanning is useful to verify previous test results. Merchants will have the flexibility to test wireless networks off-schedule when desired.

By using the payment card POS as a wireless network sensor, merchants can test the networks in the majority of the CDE. The card readers will be able to run tests in all the card payment locations in all the merchant sites. By testing from the payment card POS, merchants can test the local networks in locations that are a challenge for distant wireless network scanning because of physical or radio interference.

### BRIEF DESCRIPTION OF THE DRAWINGS

FIG. 1 is a payment card POS accepting beacon frames from surrounding Wi-Fi access points and sending information to a centralized server;

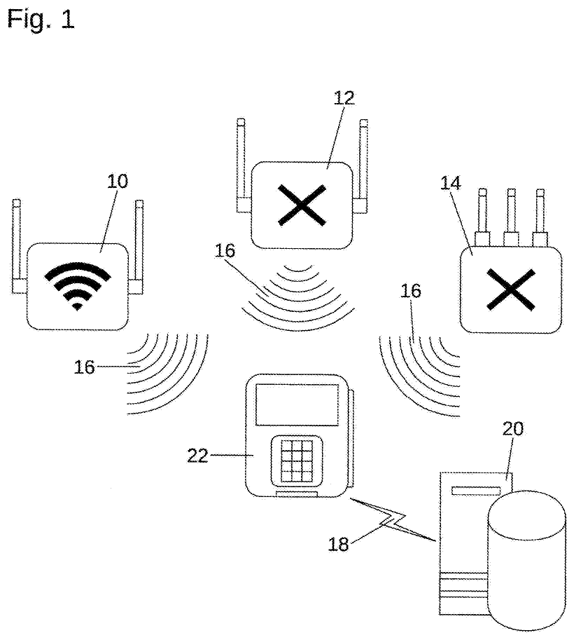

FIG. 2 is a vendor point of sale system with an integrated payment card POS accepting beacon frames from surrounding Wi-Fi access points and sending information to a centralized server;

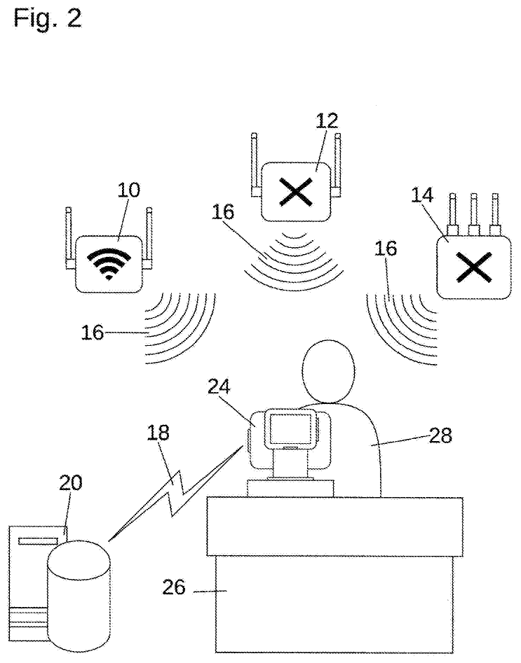

FIG. 3 is a vending machine with installed payment card POS accepting beacon frames from surrounding Wi-Fi access points and sending information to a centralized server;

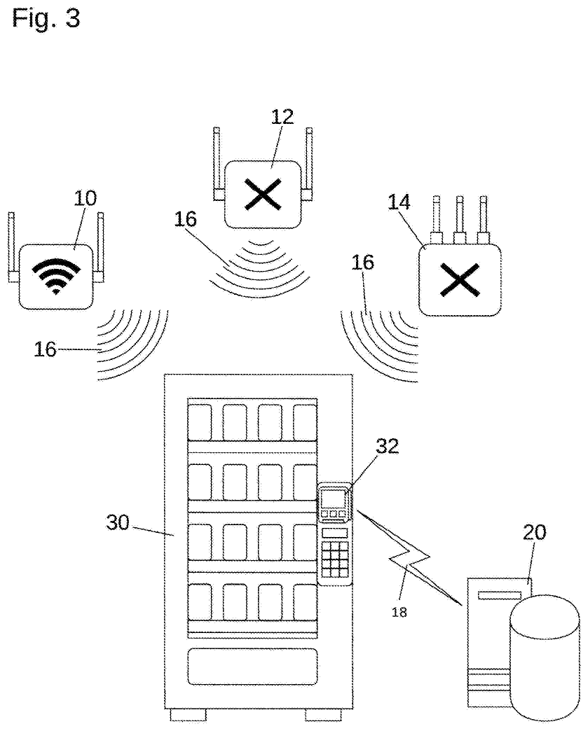

FIG. 4 is a mobile handheld payment card POS accepting beacon frames from surrounding Wi-Fi access points and sending information to a centralized server;

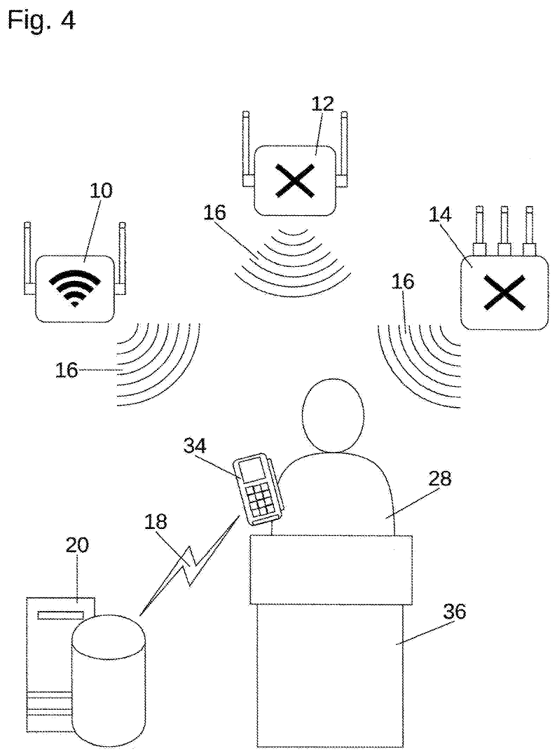

FIG. 5 is an administrator communicating with a centralized server to issue scanning commands to remote payment card POS devices and viewing reports collected on the centralized server;

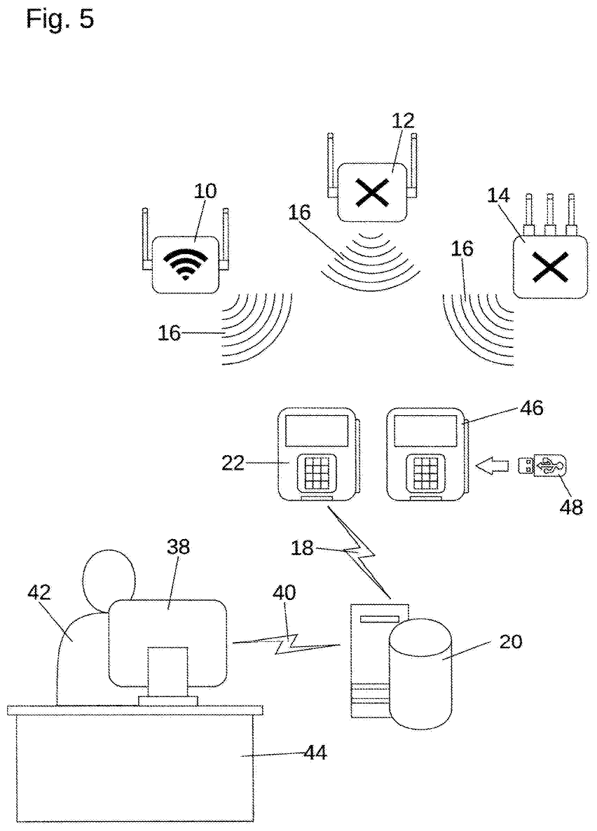

### DETAILED DESCRIPTION OF THE INVENTION

Using a system command command similar to the Linux and Android operating systems “iwlist” or the Microsoft Windows “netsh”, a payment card POS device 22 will listen for beacon frames 16 broadcasted by surrounding authorized 10, misconfigured 12, and unauthorized 14 wireless networks access points (AP). Beacon frames will contain information such as the service set identifier (SSID), basic service set identifier (BSSID), security capabilities, and channel. This information is combined with the payment card POS device unique identifier and time of listening to create the scan data.

Said scan data is sent over the merchant/vendor's approved network 18 to a centralized server 20. If the payment card POS device cannot establish an immediate connection to the centralized server, the scan data can persist on the device until connection is reestablished or the data is manually moved onto an external storage device 48.

The scan data on the centralized server is normalized, sorted, and stored for analysis. Analysis of the data's elements can identify anomalies to the Wi-Fi networks in the area surrounding the payment card POS device.

By reviewing the recorded SSIDs, misconfigured SSID names (typos or inconsistencies) can be identified on otherwise authorized APs. SSID name lists can also identify unauthorized SSIDs not created by the merchant. If observed over time, persistent unauthorized SSIDs may indicate a threat to the merchant's network.

In reviewing the recorded BSSIDs, unauthorized APs are identified by the AP hardware. If an AP uses an approved SSID but the hardware type is off-standard, then this could indicate an unauthorized AP.

Reviewing the security capabilities of the recorded beacon frames can ensure the proper level of encryption is enabled on the Wi-Fi network. Incorrect encryption types on known APs indicate a misconfigured or unauthorized AP. Analysis of the security capabilities of the surrounding Wi-Fi networks can also help to validate PCI requirements to use strong encryption on Wi-Fi networks (PCI-DSS 2.1.1 and 4.1.1).

Wireless network channel review identifies misconfigured and unauthorized WI-FI networks if said networks are not on a standard channel. Channel review also identifies channel saturation in the physical area of the payment card POS affecting the merchant's WI-FI network availability.

Combining the analysis of the recorded data elements and the known location of the payment card POS that recorded the beacon frames, location can be roughly established for any of the detected APs. With the location, APs can be verified to be in the correct location. If action is required, such as removing a detected rogue AP, the reviewers of the data will have a rough location to begin the search for said rogue AP.

Payment card POS devices to utilize this method may include self-contained payment card POS devices, vendor point of sale system with an integrated payment card POS device 24, vending machine 30 installed payment card POS devices 32, and/or mobile hand-held payment card POS devices 34. Said devices may be unattended, operated by a merchant 28 at a merchant fixed location 26, or by a merchant at a merchant satellite location 36.

The command to enable network listening on the payment card POS device is scheduled to run at a designated time, a reoccurring time, or as a single manual start scan. The listening scans can be scheduled or started either though an on-device interface 46 or from an administrator terminal 38 by a remote administrator 42 at a remote location 44 over a network connection between administrator terminal and centralized server 40.

What is claimed is:

1) A method and use of software and hardware of a payment card POS device to scan and collect information about surrounding Wi-Fi networks.

2) The method of claim 1, wherein said payment card POS device collects the available SSIDs, BSSIDs, channels, encryption types, and signal strengths of the surrounding Wi-Fi networks.

3) The method of claim 1, wherein said Wi-Fi scans are scheduled or started instantly by a remote administrator from a centralized server.

4) The method of claim 1, wherein said Wi-Fi scans are scheduled or started instantly through an on-device interface.

5) The method of claim 1, wherein said information collected in a centralized server is processed for risks and anomalies and generates reports of findings.

6) The method of claim 1, wherein said information can persist on the payment card POS until failed transmissions are reestablished or the data is manually removed onto an external storage device.
